(19) United States
(12) Patent Application Publication
(10) Pub. No.: US 2007/0215208 A1
(43) Pub. Date: Sep. 20, 2007

(54) Float type steam trap

(76) Inventors: Soon Kyu Joo, Seoul (KR); Seon Kyu Joo, Flushing, NY (US)

Correspondence Address: PARK LAW FIRM, 3255 WILSHIRE BLVD, SUITE 1110, LOS ANGELES, CA, 90010, US

(21) Appl. No.: 11/484,125

(22) Filed: Jul. 11, 2006

(30) Foreign Application Priority Data
Mar. 14, 2006 (KR) 10-2006-0023657

(51) Int. Cl. F16T 1/30

(52) U.S. Cl. 137/185

(57) ABSTRACT

The present invention relates to a steam trap, and more particularly, to a float type steam trap that is configured to have a gas discharging part mounted at the inside thereof, thereby conducting effective removal of gas generated during the operation of a heat exchanger of a boiler.

### BACKGROUND OF THE INVENTION

1. Field of the Invention

The present invention relates to a steam trap, and more particularly, to a float type steam trap that is configured to have a gas discharging part mounted at the inside thereof, thereby conducting effective removal of gas generated during the operation of a heat exchanger of a boiler.

2. Background of the Related Art

In general, a steam trap, which is usually used for a heat exchanger, is a kind of automatic valve designed to effectively eliminate condensate generated by the condensation of steam in a drum or pipe and to prevent the steam from being leaked.

Examples of conventional steam traps are disclosed in U.S. Pat. Nos. 4,630,633 and 5,065,785. Under the above construction, a bucket is formed in a head part of the steam trap in such a manner as to be movable by steam and condensate, and a vent is formed at one side of the upper part of the bucket such that the bucket closes an outlet formed at the upper part thereof by the steam pressure flowing to the vent, and if the steam is discharged to the vent, the outlet is opened by the bucket's own weight. The above-described operations are repeatedly conducted periodically to discharge the steam and condensate.

When condensate is generated in the pipe line, generally, the steam trap is operated to discharge the condensate. However, even though the condensate is not generated, the conventional steam trap with the bucket formed at the head part thereof conducts the discharging operation periodically, and also, even when the condensate exists in the steam trap, it is discharged only with the movement of the bucket, such that a relatively large amount of steam is unfortunately leaked from the steam trap.

For example, when steam is vented from a chimney of a laundry, it is caused from the operation failure of the bucket-type steam trap, and also, since a boiler should be continuously operated by the loss of steam generated from existing bucket type steam traps upon setting the steam pressure of a boiler, energies like gas, electricity, and water requisite to the activation of the boiler are enormously lost.

Furthermore, as the boiler is kept worked, the peripheral devices have relatively short life periods, and actually, the boiler has a larger capacity than the real use capacity thereof.

To solve the disadvantages the conventional bucket type steam traps have, a float type steam trap is disclosed in U.S. Pat. No. 4,623,091. Under the above configuration, an inflow pipe and an outlet are formed in perpendicular relation to each other such that condensate flows by its own weight from the interior of the mechanisms or the lower portion of the steam piping to gather the steam trap, and in this case, if the mechanisms are formed at relatively low heights, there are some difficulties that the use is impossible, the formation of the piping of discharging pipe lines is complicated, and a structure where a valve plug closes the outlet is unreasonable thus to fail to make the closing rigid. Moreover, the float should be spaced from a pin (hinge) by a relatively long distance in order to obtain a floating force resistant to the valve plug, arm, and float, the size of the steam trap has to be larger when compared with the capacity of boiler, which makes the production costs undesirably high.

The above-mentioned conventional steam trap exhibits a relatively slow operating speed to make the time period needed to close and open a through hole much consumed, thereby causing enormous losses of steam.

On the other hand, as shown in FIG. 1, if a steam trap 50 is mounted at a position where an outflow passageway 40 is formed lower than an inflow passageway 30, there is a problem that an exit pipe in the steam trap 50 is closed at a state where no condensate exists when gas is generated by means of a heat exchanger, such that as the gas is not discharged, the steam trap 50 is not operated.

### SUMMARY OF THE INVENTION

Accordingly, the present invention has been made in view of the above-mentioned problems occurring in the prior art, and it is an object of the present invention to provide a float type steam trap that is configured to have a gas discharging part mounted at the inside thereof, thereby making the gas discharging part mounted at every position of the pipe line thereof.

It is another object of the present invention to provide a float type steam trap that is configured to have a gas discharging part mounted movably along a pipe line formed thereon such that a moving member of the gas discharging part is moved along a head member thereof, thereby having a desired operating state in accordance with the use environment thereof.

To accomplish the above objects, according to the present invention, there is provided a float type steam trap including a body, a cover coupled to the body, and a float disposed in the body, the body having an inflow pipe, a discharging pipe and a discharging passageway for allowing condensate and steam to flow in and out therethrough, the steam trap including: an arm coupled at a center portion of the bottom end of the float; a lever coupled with the arm by means of a hinge; a gate coupled with the lever by means of a pin and having an orifice formed at the inside thereof; a valve plug for opening and closing the orifice of the gate; a strainer arranged above the float; and a gas discharging part formed at the inside of the strainer.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is an exemplary view showing the installation of a conventional steam trap;

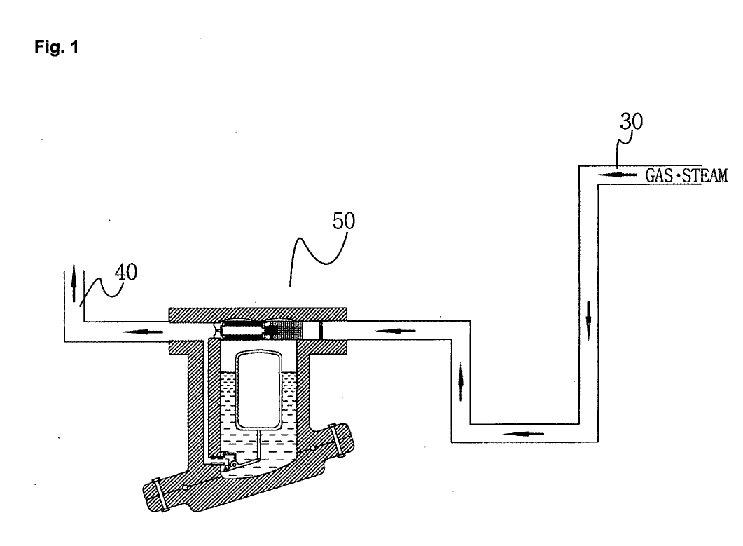

FIG. 2 is an exemplary view showing the construction of a float type steam trap according to the present invention;

FIG. 3 is an exemplary view showing the construction of a gas discharging part of the steam trap according to the present invention;

FIG. 4 is a view showing an initial state where condensate does not enter a body of the steam trap of this invention;

FIG. 5 is a view showing the operation of the gas discharging part of the steam trap according to the present invention; and

FIG. 6 is a view showing a state where condensate is contained by a predetermined quantity in the body of the steam trap of this invention.

### DETAILED DESCRIPTION OF THE PREFERRED EMBODIMENT

The present invention relates to a steam trap like a kind of automatic valve designed to effectively eliminate condensate generated by the condensation of steam in a drum or pipe and to prevent the steam from being leaked, and more particularly, to a float type steam trap that is configured to have a gas discharging part mounted at the inside thereof, thereby conducting effective removal of gas generated during the operation of a heat exchanger of a boiler.

Now, an explanation of the float type steam trap according to a preferred embodiment of the present invention will be given with reference to the attached drawings.

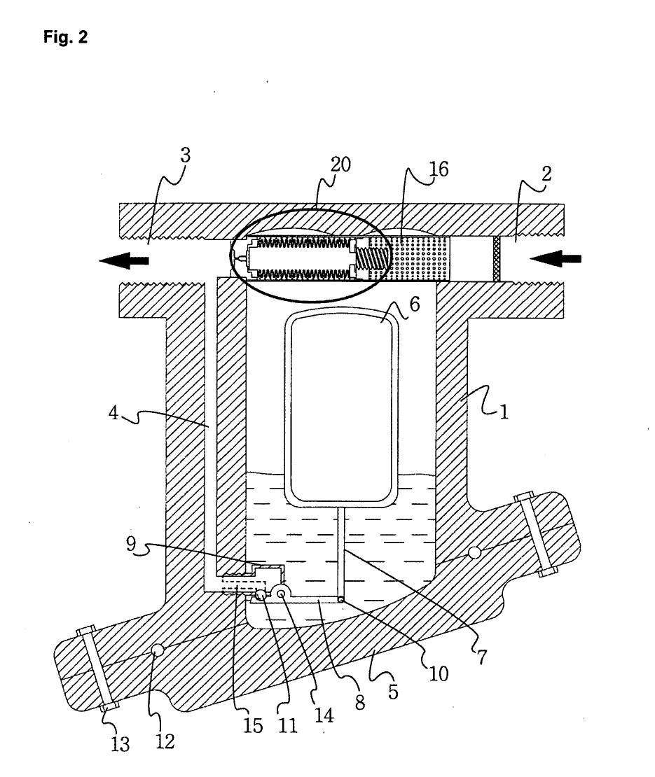

FIG. 2 is an exemplary view showing the construction of a float type steam trap according to the present invention, and

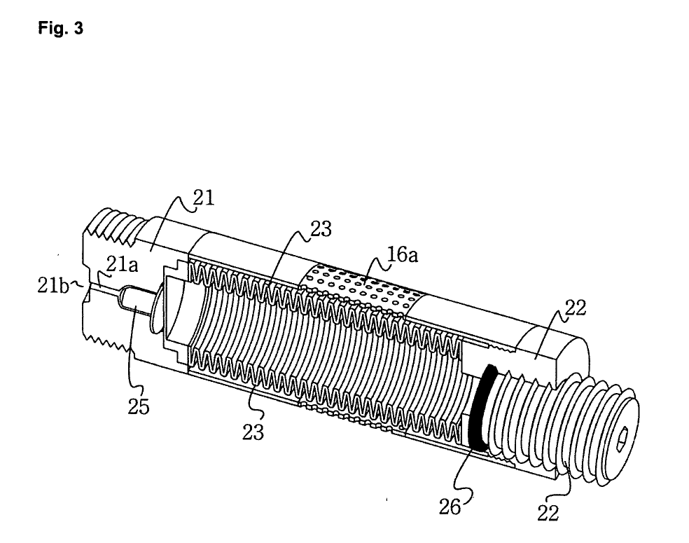

FIG. 3 is an exemplary view showing the construction of a gas discharging part of the steam trap according to the present invention.

As shown, according to the present invention, there is provided a float type steam trap including a body 1, a cover 5 coupled to the body 1, and a float 6 disposed within the body 1, the body having an inflow pipe 2, a discharging pipe 3 and a discharging passageway 4 for allowing condensate and steam to flow in and out therethrough, the steam trap including: an arm 7 coupled at a center portion of the bottom end of the float 6; a lever 8 coupled with the arm 7 by means of a hinge 10; a gate 9 coupled with the lever 8 by means of a pin 14 and having an orifice 15 formed at the inside thereof; a valve plug 11 for opening and closing the orifice 15 of the gate 9; a strainer 16 formed above the float 6; and a gas discharging part 20 formed at the inside of the strainer 16.

Reference numerals 12 and 13 which are not discussed above denote an O-ring and a coupling bolt.

In this case, the gas discharging part 20 includes: a head member 21 screw-coupled to a pipe line formed in the steam trap and having a through hole 21a formed at the inside thereof; a moving member 22 screw-coupled within the head member 21 in such a manner as to be movable along the pipe line; a bellows valve 23 fixedly coupled to the moving member 22 and expanded or contracted in response to a temperature variation; and a ball 25 formed at one end of the bellows valve 23 for opening and closing the through hole 21a of the head member 21.

Preferably, the moving member 22 has a packing 26 formed at one side thereof for preventing the liquid in the bellows valve 23 from being leaked from the bellows valve 23, and the packing 26 can be tightly contacted with the moving member 22 by means of a bolt coupled to the moving member 22.

Also, the packing 26 is desirably formed of a metal material that is not melted at a high temperature.

The bellows valve 23 is expanded or contracted in response to a temperature variation, and it is desirably contained with volatile liquid expandable and contractible in response to heat variation. The volatile liquid is water, alcohol, and so on, and in some cases, antifreeze solution may be added to water.

The bellows valve 23 is very sensitive to a temperature. If the temperature is low, it is contracted to open the through hole 21a, and contrarily, if high, it is expanded to close the through hole 21a, which causes a relatively high operating speed to greatly reduce the losses of steam.

The head member 21 is covered with the strainer 16a thereon except that the portion where a screw thread is formed at the inside thereof, that is, the portion where the moving member 22 is coupled therewith, for making gas or steam flow into the head member 21.

Further, the head member 21 has a driver groove 21b formed at the outside thereof in such a manner as to be rotatable along the pipe line after the coupling with the pipe line.

That is, as the driver groove 21b is rotated by means of a jig, the gas discharging part 20 can be moved forwardly or backwardly in accordance with the rotated direction.

In addition to the forward or backward movement of the gas discharging part 20, the moving member 22 that is screw-coupled to the head member 21 is movable at the inside of the head member 21. In more detail, a bolt 24 is coupled at one side of the moving member 22, and if the bolt 24 is rotated, the moving member 22 is moved along the screw thread within the head member 21.

At this time, the moving member 22 is fixedly coupled with the bellows valve 23, and thus, if the bolt 24 is more fastened, the moving member 22 is inserted into the head member 21, such that the through hole 21a of the head member 21 is in close contact with the ball 25 of the bellows valve 23.

Thus, as the position of the moving member 22 is adjusted, the interval between the through hole 21a and the ball 25 is controlled, which enables the operating time period required for opening and closing the through hole 21a to be controlled.

Hereinafter, an explanation of an operation of the float type steam trap according to the present invention will be given.

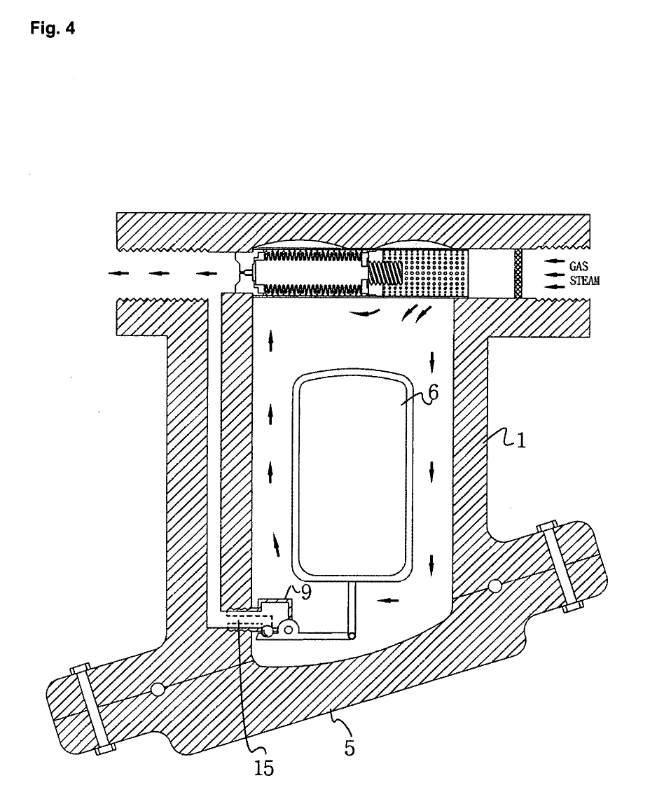

First, FIG. 4 is a view showing an initial state where condensate does not enter the body of the steam trap of this invention, wherein the float 6 is placed at the bottom portion of the body 1, and the valve plug 11 closes the orifice 15 of the gate 9.

At this time, if the heat exchanger of a boiler is operated, steam and gas enter the body 1, and in this state, as the orifice 15 of the gate 9 is closed by means of the valve plug 11, the steam and gas, which are not discharged from the discharging passageway 4, push the bellows valve 23 toward the moving member 22.

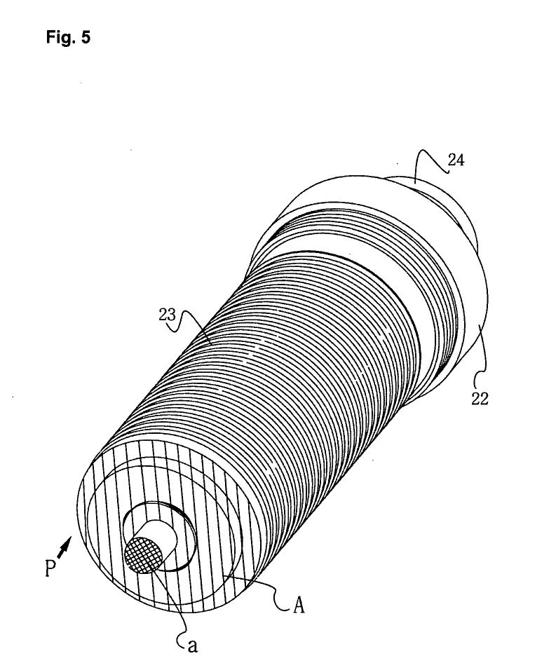

Referring to FIG. 5, as the bellows valve 23 is fixed to the moving member 22 at one end thereof and is free at the other end thereof, a pushing force P of high pressure of gas and steam is applied to an area A-a that is obtained by subtracting a sectional area a of the ball 25 from the sectional area A of the bellows valve 23, such that the ball 25 closing the through hole 21a of the head member 21 is moved toward the moving member 22, thereby making the through hole 21a opened.

After that, the gas and steam are vented through the through hole 21a.

If condensate is filled in a large quantity in the body 1 upon an initial operation, a low temperature of water can be discharged together with the gas and steam through the through hole 21a.

At this time, as the steam is discharged, the volatile liquid that is filled in the bellows valve 23 becomes volatile and expanded to close the through hole 21a again, and as a result, if the body 1 of the steam trap reaches a high pressure, the steam is condensed and changed to water.

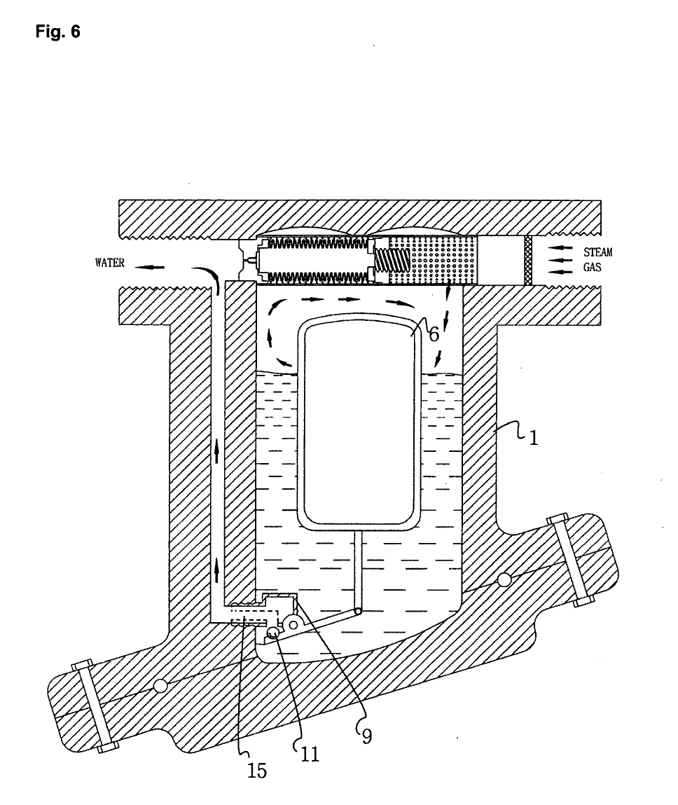

FIG. 6 is a view showing a state where condensate is contained by a predetermined quantity in the body of the steam trap of this invention, wherein the float 6 is floated over the condensate to allow the valve plug 11 to open the orifice 15 of the gate 9, such that the condensate is drained to the discharging pipe 3 along the discharging passageway 4.

At this time, if the condensate enters the inflow pipe 2, it gathers into the body 1 to make the float 6 floated, thereby opening the orifice 15 of the gate 9.

Generally, since the interior of the steam trap is kept at a substantially higher pressure when compared with the atmospheric pressure, the condensate is drained through the discharging passageway 4 and the discharging pipe 3 to the outside, and after that, the float 6 is placed at the bottom portion of the body 1 to close the orifice 15, thereby stopping the discharging of condensate.

Under the repetition of the above-discussed operation, the high temperature of steam is not allowed to be leaked from the discharging pipe 3, thereby enhancing the efficiency of the heat exchanger of a boiler.

As described above, the float type steam trap according to the present invention is provided with a gas discharging part formed at the inside thereof in such a manner as to be controlled at its installation position, thereby gently discharging the gas generated by the initial operation of a heat exchanger of a boiler.

That is to say, the present invention has a substantially high operation speed by using the bellows valve, and thus, air exit failure, condensate exit failure, and gas exit failure may happen at an initial state of the steam trap or while being used, such that when a high pressure of steam does not reach the bellows valve, the temperature of bellows valve becomes low and contracted to open the through hole, thereby discharging the air, condensate, and gas. After that, if the high pressure of steam enters the steam trap, the volatile liquid in the bellows valve becomes volatile and expanded to close the through hole, thereby preventing the steam from being leaked from the steam trap.

As a result, the steam pressure and the temperature variation in response to the steam pressure are all controlled by means of the bellows valve itself, thereby enhancing the performance of the steam trap.

Furthermore, the gas discharging part is controlled at its position along the pipe line formed in the steam trap, and the moving member of the gas discharging part is rotated to control the operational interval of the bellows valve, thereby regulating appropriate operating periods in accordance with the use environment of the steam trap. Additionally, with a relatively simple configuration, the condensate can be recycled to the boiler, thereby improving the efficiency of the heat exchanger of the boiler, and with a relatively high responding speed, the losses of steam can be greatly reduced.

What is claimed is:

1. A float type steam trap including a body, a cover coupled to the body, and a float disposed in the body, the body having an inflow pipe, a discharging pipe and a discharging passageway for allowing condensate and steam to flow in and out therethrough, the float type steam trap comprising:
an arm coupled at a center portion of the bottom end of the float;
a lever coupled with the arm by means of a hinge;
a gate coupled with the lever by means of a pin and having an orifice formed at the inside thereof;
a valve plug for opening and closing the orifice of the gate;
a strainer formed above the float; and
a gas discharging part formed at the inside of the strainer.

2. The float type steam trap according to claim 1, wherein the gas discharging part comprises: a head member screw-coupled to a pipe line formed in the steam trap and having a through hole formed at the inside thereof; a moving member screw-coupled within the head member in such a manner as to be movable along the pipe line; a bellows valve coupled to the moving member and contractible in response to a temperature variation; and a ball formed at one end of the bellows valve for opening and closing the through hole of the head member.

3. The float type steam trap according to claim 2, wherein the bellows valve has volatile liquid contained therein.

4. The float type steam trap according to claim 2, wherein the head member has the strainer partially formed thereon.

5. The float type steam trap according to claim 2, wherein the head member has a driver groove formed at the outside thereof in such a manner as to be rotatable by means of a jig such that the gas discharging part is movable within the pipe line.

6. The float type steam trap according to claim 2, wherein the moving member has a packing formed at one side thereof for preventing the liquid in the bellows valve from being leaked from the bellows valve.
